(19) United States
(12) Patent Application Publication
(10) Pub. No.: US 2017/0264059 A1
(43) Pub. Date: Sep. 14, 2017

(54) POWERED WALL PLATE SYSTEM FOR AN ELECTRICAL OUTLET

(71) Applicant: Scott E. Cote, Manchester, NH (US)

(72) Inventor: Scott E. Cote, Manchester, NH (US)

(21) Appl. No.: 15/457,843

(22) Filed: Mar. 13, 2017

Related U.S. Application Data
(60) Provisional application No. 62/307,538, filed on Mar. 13, 2016.

(51) Int. Cl. H01R 25/00; H01R 24/62; H01R 13/52; H01R 13/717; H01R 13/641; H01R 24/28; H01R 13/506

(52) U.S. Cl. CPC H01R 25/006; H01R 24/28; H01R 24/62; H01R 13/506; H01R 13/717; H01R 13/641; H01R 13/5213; H01R 2107/00

(57) ABSTRACT

Systems and devices are disclosed for a powered wall plate for an electrical outlet. The system includes a wall plate and a cable. The wall plate includes a conductor having a first end to engage a socket of the outlet. The wall plate is attached to the outlet and covers two or more sockets of the outlet. The cable includes a first cable end and a second cable end. The first cable end includes a connector to engage a second end of the conductor of the within the wall plate. The second cable end includes an additional electrical outlet. In some embodiments, the powered wall plate system includes a base plate, and the base plate includes a cavity therein. The wall plate is disposed within the cavity and attached to the electrical outlet. An exterior cover plate is positioned over the wall plate and on the base plate.

### CROSS-REFERENCE TO RELATED APPLICATIONS

This application claims the benefit of U.S. Provisional Patent Application No. 62/307,538 filed on Mar. 13, 2016, which is herein incorporated by reference in its entirety.

### FIELD OF THE DISCLOSURE

This disclosure relates to electrical systems, and more particularly to powered wall plates for outlets of electrical systems.

### BACKGROUND

Electrical power is used to operate many electronic devices, such as computers, televisions, and appliances, within many different areas, for example homes, offices or retail spaces. These areas typically include one or more electrical circuits to distribute electrical power from a main electrical source, such as a power panel, throughout the area. The power can be accessed through electrical outlets, such as a single receptacle, a duplex receptacle or ground fault circuit interrupter (GFCI) receptacle. The outlets can be mounted to many different surfaces of the area, such as interior and exterior walls, floors, and ceilings, using electrical boxes. Electrical power is transferred to an electrical device within the area when the device is electrically connected to the outlet. An electrical connection is made when a power cord attached to the device is plugged into or otherwise connected to the outlet.

### SUMMARY

One example embodiment of the present disclosure provides a powered wall plate system for an electrical outlet including a wall plate including a conductor having a first end and a second end, the first end of the conductor extending to be electrically engageable with at least one socket of the electrical outlet, wherein the wall plate is to be attached to the electrical outlet such that the wall plate is to cover the at least one socket of the electrical outlet; and a removable cable including a first cable end and a second cable end, the first cable end includes a connector to engage the second end of the conductor at an angle of about 90 degrees with respect to the first end of the conductor, and the second cable end to include an additional electrical outlet. In some cases, the system includes a base plate to receive the wall plate, the base plate to be installed on an electrical box that contains the electrical outlet and includes a cavity therein to receive the wall plate; and an exterior cover plate to be attached to the base plate so as to at least one of cover the wall plate and surround a perimeter of the wall plate. In other cases, the at least one socket of the electrical outlet is a double socket, and the wall plate is to surround the electric outlet such that the double socket and one or more integrated features of the electric outlet are covered by the wall plate. In yet some other cases, the base plate includes in a flange to receive the exterior cover plate and define the cavity within the base plate, and the flange includes a locking feature to secure the exterior cover plate onto the base plate. In some cases, the base plate and the electrical outlet are attached to the electrical box. In other cases, the base plate includes one or more grooves to receive one or more corresponding features located on the exterior cover plate to secure the exterior cover plate to the base plate. In some cases, the wall plate is installed onto the electrical outlet separately from the base plate and the exterior cover plate such that the wall plate is moveable relative to the base plate. In other cases, the exterior cover plate includes a locking feature to secure the exterior cover plate to the base plate. In some other cases, the exterior cover plate is positioned onto the base plate such that the wall plate cannot be accessed. In yet other cases, the exterior cover plate can be removed from the base plate by pivoting the exterior cover plate relative to the base plate. In some other cases, the connector includes a tab, the tab is to prevent removal of the connector from the wall plate when the exterior cover plate is installed on the base plate. In yet other cases, the wall plate is moveable relative to the base plate and exterior cover plate when each of the wall plate, base plate and exterior cover plate are installed. In some cases, the system includes an opening disposed within the wall plate and an insert, the insert to be received within the opening. In some such cases, the opening provides access to a portion of the electrical outlet that does not include the at least one socket. In other cases, the additional electrical outlet includes at least one of a light, an indicator, and a universal serial bus (USB) port.

Another example embodiment of the present disclosure provides a powered wall plate system for an electrical outlet including a base plate to be installed onto an electrical box that contains the electrical outlet, the base plate in contact with a surface that includes the electrical outlet and includes at least one tab for mounting the base plate to the electrical box and a flange that defines a cavity; a wall plate disposed within the cavity of the base plate and to cover sockets of the electrical outlet, the wall plate further comprising a conductor having a first end, the first end of the conductor is a plug to engage a socket of the electrical outlet, an opening to provide access to a portion of the electrical outlet that does not include the sockets of the electrical outlet, and an insert installed within the opening, the insert attached to the wall plate with a fastener that engages the electrical outlet; an exterior cover plate to be installed onto the flange of the base plate and over the wall plate, the exterior cover plate including one or more locking features that engage the flange of the base plate to secure the exterior cover plate thereon; and a cable including a first cable end and a second cable end, the first cable end including a connector to engage a second end of the conductor of the wall plate, and a distributor connected to the second cable end.

Another example embodiment of the present disclosure provides a powered wall plate system for an electrical outlet including a base plate to be installed on an electrical box that contains the electrical outlet, the base plate in contact with a surface that includes the electrical outlet and includes a cavity therein; a wall plate disposed within the cavity of the base plate and to cover sockets of the electrical outlet, the wall plate further comprising a conductor having a first end, the first end of the conductor to engage at least one socket of the electrical outlet, and an opening to provide access to a portion of the electrical outlet that does not include the sockets; and an exterior cover plate to be positioned onto the base plate so as to cover the wall plate. In other instances, the system includes a removable cable including a first cable end and a second cable end, the first cable end includes a connector to engage a second end of the conductor of the wall plate, and the second cable end includes an additional electrical outlet. In some such instances, the first cable end cannot be removed from the second end of the conductor of the wall plate when the exterior cover plate is installed onto the base plate. In some other instances, the system includes an insert positioned in the opening to secure the wall plate to the electrical outlet with a fastener, the fastener is in contact with the insert and engages the electrical outlet.

The features and advantages described herein are not all-inclusive and, in particular, many additional features and advantages will be apparent to one of ordinary skill in the art in view of the drawings, specification, and claims. Moreover, it should be noted that the language used in the specification has been selected principally for readability and instructional purposes and not to limit the scope of the inventive subject matter.

### BRIEF DESCRIPTION OF THE DRAWINGS

FIG. 1 is a front view of an electrical outlet mounted to a wall within an area, in accordance with an embodiment of the present disclosure.

FIG. 2 is a cross-sectional view of the electrical outlet of FIG. 1, in accordance with an embodiment of the present disclosure.

FIG. 3A is a front view of a powered wall plate system installed on an electrical outlet within the area, in accordance with an embodiment of the present disclosure.

FIG. 3B is a side view of the powered wall plate system of FIG. 3A, in accordance with an embodiment of the present disclosure.

FIG. 4A is a front view of a wall plate of the powered wall plate system, in accordance with an embodiment of the present disclosure.

FIG. 4B is a rear view of the wall plate shown in FIG. 4A, in accordance with an embodiment of the present disclosure.

FIG. 5A is a front view of an insert of the powered wall plate of FIGS. 4A-B, in accordance with an embodiment of the present disclosure.

FIG. 5B is a rear view of the insert shown in FIG. 5A, in accordance with an embodiment of the present disclosure.

FIG. 6A is a front view of a cable of the powered wall plate system, in accordance with an embodiment of the present disclosure.

FIG. 6B is a side view of the cable shown in FIG. 6A, in accordance with an embodiment of the present disclosure.

FIG. 7A is a front view of a connector disposed on the cable for the powered wall plate system, in accordance with an example embodiment of the present disclosure.

FIG. 7B is a rear view of the connector of FIG. 7A, in accordance with an example embodiment of the present disclosure.

FIG. 8A is a front view of a powered wall plate system installed on an electrical outlet within the area, in accordance with another embodiment of the present disclosure.

FIG. 8B is a side view of the powered wall plate system of FIG. 8A, in accordance with another embodiment of the present disclosure.

FIG. 9 is a perspective view of the powered wall plate system of FIGS. 8A-8B, in accordance with an embodiment of the present disclosure.

FIG. 10 is an exploded view of the powered wall plate system of FIG. 9, in accordance with an embodiment of the present disclosure.

FIG. 11A is a front view of a base plate of the powered wall plate system, in accordance with an embodiment of the present disclosure.

FIG. 11B is a rear view of the base plate shown in FIG. 11A, in accordance with an embodiment of the present disclosure.

FIG. 12A is a front view of an exterior cover plate of the powered wall plate system, in accordance with an example embodiment of the present disclosure.

FIG. 12B is a rear view of the exterior cover plate of FIG. 10A, in accordance with an example embodiment of the present disclosure.

These and other features of the present embodiments will be understood better by reading the following detailed description, taken together with the figures herein described. The accompanying drawings are not intended to be drawn to scale. For purposes of clarity, not every component may be labeled in every drawing.

### DETAILED DESCRIPTION

In one aspect, a system and devices are disclosed for a powered wall plate for an electrical outlet (e.g., a duplex electrical receptacle) disposed within an area, such as a home or office. The powered wall plate system includes a wall plate and a removable cable. The wall plate is attached to the outlet, such that the wall plate surrounds the outlet so that electrical connections between the outlet and a main power source are not accessible to humans or pets. When installed, the wall plate can cover the sockets of the outlet and eliminate access points that can result in electrical injury. The wall plate includes conductors having a first end to engage a socket of the outlet. Attached to the wall plate is a removable cable that includes a first cable end and a second cable end. The first cable end includes a connector configured to engage a second end of the conductor within the wall plate to receive electrical power from the outlet. The second end of the wall plate conductor may be oriented at an angle of 90 degrees to the first end of the wall plate conductor that mates with the outlet. The cable can further include an additional electrical outlet at the second cable end. When installed in the additional outlet, power cords for electrical/electronic appliances can be neatly arranged to maintain a desire aesthetic look or appearance within the area. In some embodiments, the powered wall plate system includes a base plate installed on or otherwise secured to the electrical box that contains the outlet. The base plate can be mounted flush or otherwise in contact with a surface (e.g., a wall) that contains the outlet and includes a cavity to receive the wall plate. An exterior cover plate can be positioned over the wall plate and onto the base plate to conceal or otherwise hide the wall plate from view and provide an aesthetic appearance within the area. The system can exhibit a low profile, providing reduced clearance requirements for furniture compared to the clearance required for traditional plugs that are installed into a standard outlet at 90 degrees and may extend out for 1, 1.5, 2 or 2.5 inches before turning downward, upward or to one side.

General Overview

Electrical outlets, such as wall outlets, provide access to electrical power from a main electrical source and can be located throughout an area (e.g., a room), such that they are easily accessible by persons in the area. As a result of their location, these outlets are often visible and thus power cords plugged into the electrical outlets are also visible. The power cords may appear unkept (e.g., appear twisted or tangled with one another) or otherwise adversely affect an aesthetic appearance of the area. In addition, electrical outlets can pose a danger to persons, especially small children, when the sockets of the outlets are left exposed. Persons, such as small or young children, are likely to misuse electrical power from an electrical outlet because electrical outlets are easily within their reach and they are unable to recognize or understand the dangers associated with improperly using an electrical outlet.

Thus, and in accordance with an embodiment of the present disclosure, systems and devices are disclosed for a powered wall plate system for an electrical outlet (hereinafter referred to as an outlet) within an area. The powered wall plate system includes a wall plate that can function as a replacement for conventional outlet cover plates. The wall plate can be configured to fit standard and ground fault circuit interrupter (GFCI) outlets. The outlets, furthermore, can be single receptacle or duplex receptacles outlets. In addition, the wall plate can also accommodate outlets that include integrated features such as universal serial bus (USB) ports and lights. Outlets may be, for example, two, three or four prong and in different embodiments can include North American outlets, Europlug outlets, German outlets, UK outlets, Australian outlets, Danish outlets, Italian outlets, Chinese outlets, Korean outlets and Japanese outlets. Outlets may provide standard power such as, for example, 110, 115, 120, 220, 230 or 240 volts. In an example embodiment, the wall plate is installed onto the outlet (without a conventional cover plate) so as to surround and isolate the electrical contacts of the outlet. Depending on the configuration, the wall plate is to mount flush or otherwise in contact with a surface (e.g., a wall) to which the outlet is mounted. When installed, the wall plate can completely enclose or otherwise surround the outlet, as described further herein. The wall plate includes two or more male conductors, each having a first end configured to engage one or more conductors of the outlet to receive electrical power from the main power source. In an example embodiment, the first end of the conductor is a plug that includes three prongs or pins and may be configured similarly to a conventional electrical plug. The conductors may be comprised of materials used to make plugs including metals such as copper, aluminum and steel. The wall plate can be attached to the outlet using a fastener, such as a machine screw. The wall plate, in some embodiments, includes an opening to provide visual and/or physical access to portions of the outlet that do not include a socket. The opening can be any size or shape sufficient to access one or more features integrated into the outlet, such as test or re-set buttons, universal serial bus (USB) ports, indicators and lights. In some embodiments, an insert can be positioned within the opening. The insert, in some instances, can be used to further secure the wall plate to the outlet. The insert may be opaque, translucent or transparent.

The powered wall plate system further includes a cable to transmit electrical power from the wall plate to an additional outlet. The cable may be permanently attached to the wall plate or may be removable. Removable cables can be electrically connected and disconnected by the user. In an example embodiment, the cable is a round cable with a sheath, insulation, two conductor wires (e.g., copper wires) and a ground wire. The cable also includes a first cable end and a second cable end. Attached to the first cable end is a connector (e.g., a three prong or pin connector) that is configured to engage a second end of the conductor of the wall plate. These connectors may be configured differently from wall socket plugs and may, for example, have two conductors and a ground that are in line with each other. Integrated with or otherwise attached to the second cable end is an additional outlet that provides electrical power to a power device, for example. In some embodiments, the second cable end includes a connector that may be a standard electrical connector that matches the wall outlet. Thus, in some cases, the male connector at the first end of the cable may not be compatible with the female connector at the second end. In an example embodiment, the additional outlet can be a duplex electrical receptacle. In some embodiments, the additional outlet may also include one or more features, such as control buttons, universal serial bus (USB) ports, indicators, and lights. The additional outlet, in some other embodiments, can be disposed with an electrical box connected to the cable. The cable may be substantially straight, without bends, and may be parallel to the wall. In some cases, the cable may be in contact with the wall or may extend outwardly no more than 0.5 inch, 1.0 inch or 1.5 inch from the wall. The cable may be of a length that reaches or is just short of reaching the floor. For instance, the cable may have a length of less than 4 ft, less than 3 ft or less than 2 ft. No matter its configuration, the additional outlet can be positioned to create a more pleasing aesthetic appearance by changing the location and/or the orientation of electrical appliance power cords that are powered by the electrical outlet.

In another embodiment of the present disclosure, the powered wall plate system further includes a base plate to receive the wall plate. The base plate, in an example embodiment, is installed on the electrical box that contains the outlet. The base plate includes a base and a flange that together define a cavity for receiving a wall plate, as will be described further herein. The cavity allows the wall plate to be installed onto the outlet separately from the base plate. The wall plate is adjustable in relation to the base plate and can freely and independently move relative to the base plate to accommodate for instances where the outlet is not aligned with the base plate. This independent movement of the wall plate relative to the base plate can also allow the wall plate to be installed on outlets with varying distances between their faces (e.g., a surface that includes the sockets) to surfaces (e.g., a wall) in which the outlets are mounted thereto. The base is also configured to ensure that the base plate is mounted flush with the surface in which the outlet is installed. Attached to the base is a flange for receiving an exterior cover plate. In some embodiments, the flange includes one or more locking features that secure the exterior cover plate onto the base plate. Locking features, such as grooves, ridges or dimples, can be formed in the flange using machining or injection molding techniques to receive corresponding features within the exterior cover plate.

In some embodiments, attached to the base plate is an exterior cover plate that covers or otherwise surrounds the wall plate. When installed, the exterior cover plate conceals the wall plate from view and provides an aesthetically pleasing appearance or look. The exterior cover plate can be, for example, colored to match or blend in with the wall. In an example embodiment, the exterior cover plate is positioned and secured onto the flange of the base plate. The exterior cover plate may include locking features, such as projections, protrusions, ridges or other raised material to engage corresponding locking features of the base plate, as previously described above. In some embodiments, the exterior cover plate prevents the removal of a connector (e.g., disposed on the cable) installed in the wall plate when the exterior cover plate is positioned or otherwise secured to the base plate. In other embodiments, the exterior cover plate can be installed in multiple orientations or configurations, such that when the powered wall plate system is not in use electrical power from the outlet is not accessible. Such configurations can prevent inadvertent access to electrical power by children.

Example Application

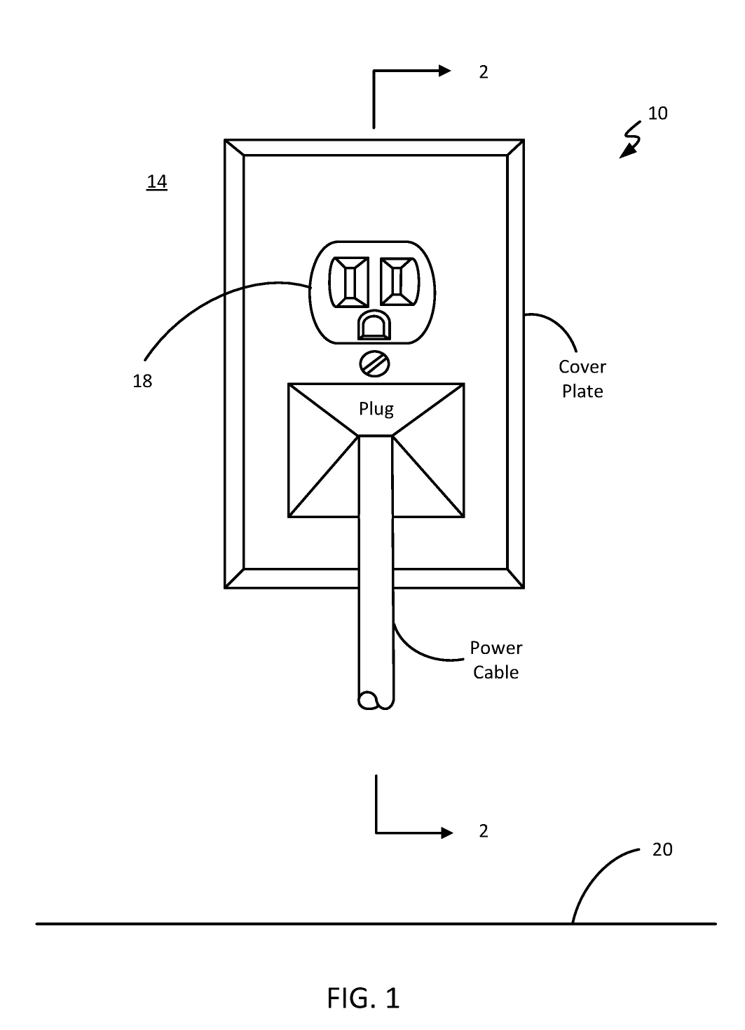

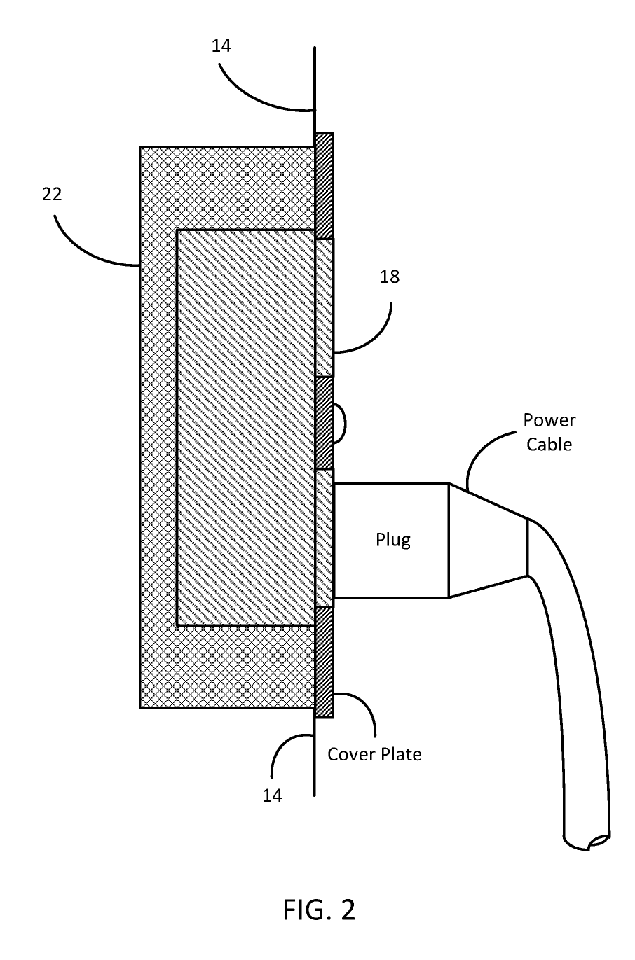

FIG. 1 illustrates a front view of an electrical outlet 18 mounted to a wall 14 within an area 10, in accordance with an embodiment of the present disclosure. FIG. 2 is a cross-sectional view of the electrical outlet 18 of FIG. 1, in accordance with an embodiment of the present disclosure. The area 10, in a general sense, can be any space or structure that includes an electrical outlet 18 for distributing electrical power from a main electrical source. The area 10, in an example embodiment is a room within a structure, such as home or office building. It is understood however that the outlet 18 can be an exterior outlet as well. The area 10 includes a wall 14 and a floor 20. In other embodiments, the area 10 may be a temporary structure or space, such as a group of cubicles, which can be removed, re-installed, or reconfigured to change a lay out or appearance of the area 10.

The area 10 includes a number of electrical outlets 18 (hereinafter referred to as outlets 18) for accessing electrical power from the main electrical source, such as a power panel. The outlets 18 are configured to provide electrical power in response to receiving a connector (e.g., a plug) of a power cable for a device, such as an electrical appliance, electric light or computing device. In an example embodiment, the outlet 18 is a duplex wall outlet wired or otherwise connected to a 15 ampere (amp) or 20 amp electrical circuit. The outlet 18, in other embodiments, can be a single receptacle outlet and/or include other integrated features. For instance, the outlet 18 can be configured as a ground fault circuit interrupter (GFCI). Such outlets often include test and reset buttons located on the front of the outlet to enable a user to reset the outlet after it has been tripped or to test the outlet to ensure proper outlet operation. Other features, such as universal serial bus (USB) ports, can also be integrated into the outlet 18 to receive power cables associated with low power electronic devices, such as smart phones and tablet devices. Numerous other outlet configurations will be apparent in light of the present disclosure.

The outlet 18 can be installed within the area 10, as shown in FIGS. 1 and 2, using an outlet box 22. The outlet box 22 houses the outlet 18 and protects the electrical connection of the wires of the electrical circuit to the outlet 18 within the space inside the wall 14. In an example embodiment, the outlet box 22 is recessed within the wall 14, such that the outlet 18 can be installed within the outlet box 22 at a desired height above the floor 20. Appropriate heights from the floor may be, for example, 12 inches, 18 inches or 24 inches. The outlet 18, in other embodiments, may be mounted to other surfaces within the area 10, for example the floor 20.

Electrical outlets, such as outlet 18, also commonly include a cover plate that surrounds but does not cover and prevent access to the outlet 18. The cover plate prevents a person from accessing electrical wires within an outlet box 22 and thus, protects users from electrical shock when they are connecting an electrical appliance to the outlet 18. The cover plate is typically manufactured from a plastic or other non-conductive material and is attached to the outlet 18 using one or more fasteners, such as a machine screw. With the cover plate installed, however, the sockets of the electrical outlet 18 are left exposed, and thus adversely affect the aesthetic appearance of the area 10 and pose an electrical risk to small children.

In addition, power cables installed in the outlet 18 can cause a loss in useable space within the area. The connection between a power cord of an electronic device and the outlet 18 causes the power cord to project or otherwise protrude into the area 10. As result, furnishings, such as a couch or bookcase, cannot be positioned directly against the wall 14 without damaging the power cord. Thus, furnishings adjacent to the outlet 18 are positioned further into the area 10 to prevent damage to the power cord and to provide access or clearance to install and disconnect the power cord from the outlet 18. These clearances may be greater than 1 inch, greater than 1.5 inch or greater than 2 inch, for example. This reduces the effective size of the room. As a result, users have less space for maneuvering through the area 10.

Example Powered Wall Plate Device Configuration

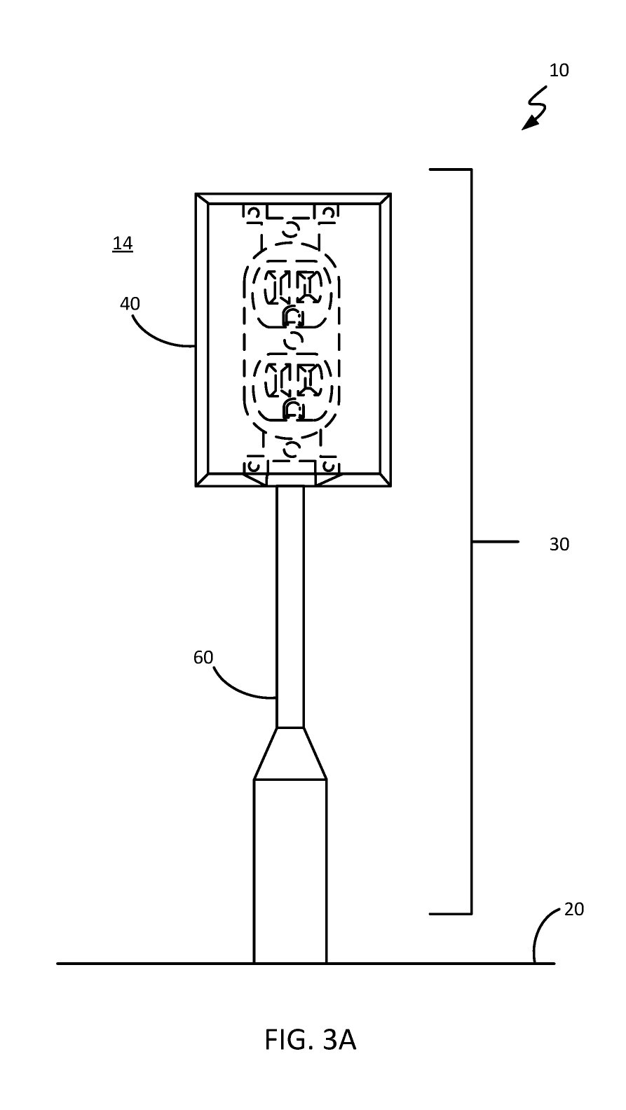

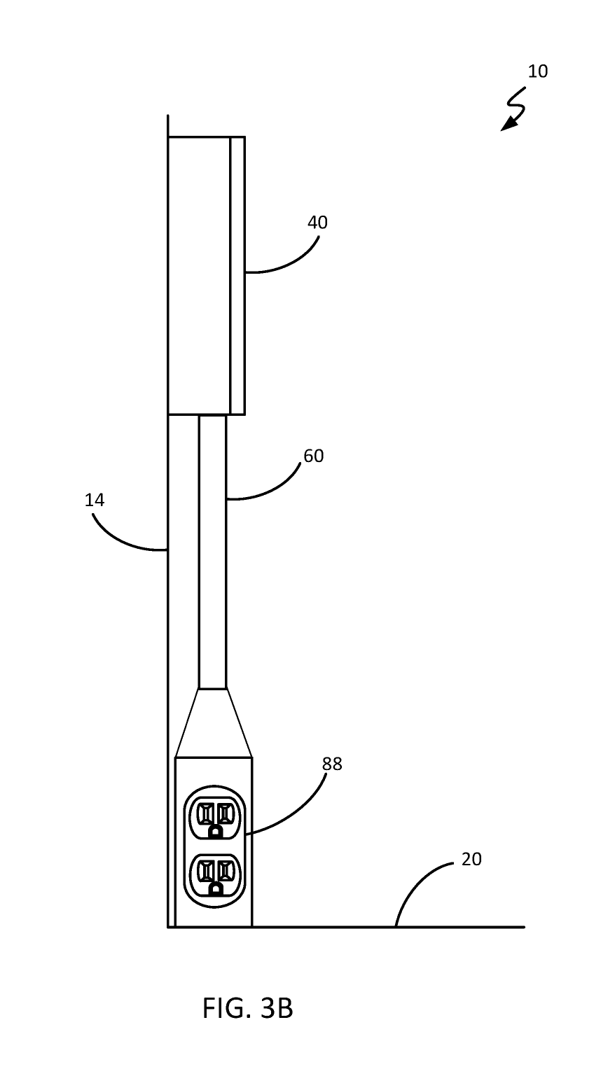

FIG. 3A is a front view of a powered wall plate system 30 installed on an electrical outlet 18 within an area 10, in accordance with an embodiment of the present disclosure. FIG. 3B is a side view of the powered wall plate system 30 of FIG. 3A, in accordance with an embodiment of the present disclosure. The powered wall plate system 30 enables power cords for electrical appliances to be positioned out of the way to achieve an aesthetically pleasing look or appearance within the area 10. In an example embodiment, the powered wall plate system 30 includes a wall plate 40 and a cable 60 with an additional outlet 88 integrated therein. As can be seen, when installed, the wall plate 40 encloses the outlet 18 (shown with dotted lines) such that the outlet 18 is no longer visible and its electrical connections are not accessible.

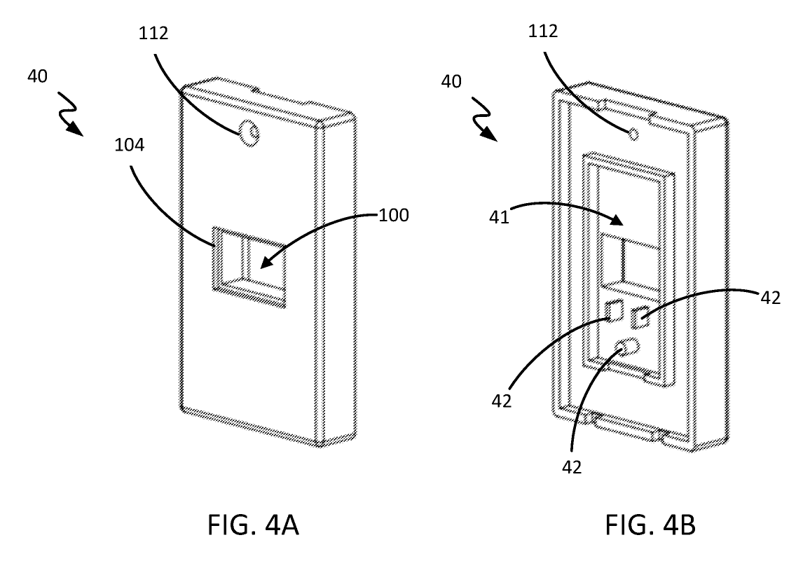

FIG. 4A is a front view of a wall plate 40 of the powered wall plate system 30, in accordance with an embodiment of the present disclosure. FIG. 4B is a rear view of the wall plate 40 shown in FIG. 4A, in accordance with an embodiment of the present disclosure. The wall plate 40 is installed onto the outlet as a replacement for a traditional cover plate. No matter whether the outlet includes one, two or more sockets therein, when installed, the wall plate 40 can be configured to cover some or all of the female openings of the sockets. The wall plate 40 is further configured to engage the outlet and transmit electrical power to the cable 60. In an example embodiment, the wall plate 40 includes a recess 41 and conductors 42 disposed therein. The recess 41 is configured to receive the outlet to allow the wall plate 40 to mount flush with the wall. Once received in the recess 41, the outlet is surrounded by the wall plate 40 to conceal electrical connections between the outlet and main power source. Furthermore, the wall plate 40 also covers the sockets of the outlet. Within the recess 41 are conductors 42 to receive electrical power from the outlet. The conductors 42 can be manufactured from conductive materials, such as copper or aluminum. In an example embodiment, the conductors 42 have a first end located within the recess 41 and configured to engage at least one socket of the outlet 18 when the wall plate 40 is installed thereon. The conductors 42 can be configured to interface with the upper socket, the lower socket or both. As can be seen, the first ends of the conductors 42 form a plug having three prongs or pins. The first end of the conductors 42 can be configured in all the same direction relative to the outlet (e.g., normal to the face of the outlet), and may be of similar or identical configuration to a plug designed to interface with the outlet. Conductors 42 should be of a length long enough to provide consistent electrical communication with the outlet but short enough to minimize the profile of the wall plate 40. In other instances, for example, the conductors 42 can be arranged or otherwise positioned in different directions relative to the outlet (e.g., one pin may be positioned horizontally relative to the face of the outlet). In other embodiments, the conductors 42 may only be two pins that engage the sockets for the outlet. The conductors 42 further include a second end configured to engage a connector of the cable attached to the additional outlet, as will be described further herein. The second end may include male or female electrical connectors that are at 90 degrees with reference to the first end of the conductors that interfaces with the outlet. Conductors 42 may be integrated with the GFCI circuit within the wall plate 40 that enables the user to add this functionality to an outlet that does not include it.

As can be seen, the wall plate 40 can optionally include an opening 100 to access portions of the outlet that do not include a socket. Such portions of the outlet may include features, such as control buttons (e.g., test and reset buttons for a GFCI outlet), USB ports, indicators, or lights. The opening 100 can be any size to enable a user to access the integrated features of the outlet while still preventing access to the electrical sockets of the outlet. In an example embodiment, the opening 100 is positioned above conductors 42 and is rectangular shaped. The opening 100, in some embodiments, may also include a ledge 104 to support or otherwise position features, such as a removable insert. The removable insert, in some embodiments, can be used to secure the wall plate 40 to the outlet, as described further herein. Numerous other wall plate configurations will be apparent in light of the present disclosure.

The wall plate 40 can optionally include an attachment point 112 for attaching the wall plate 40 to non-standard outlets (e.g., outlets that do not include threaded-hole located in the center of the outlet for attaching a cover plate, such as GFCI outlet). In an example embodiment, the attachment point 112 may be partially pre-drilled from the back surface of the wall plate 40, such that the outer surface of the wall plate 40 does not include a through hole, but can be readily drilled for one, if needed.

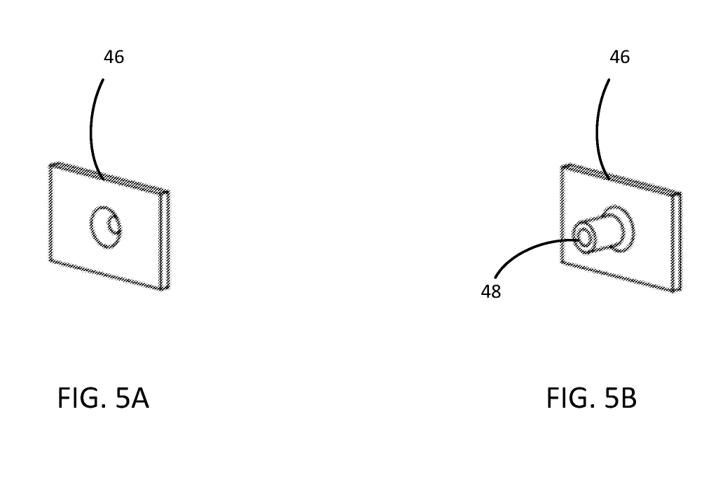

FIG. 5A is a front view of an insert 46 of the powered wall plate system 30, in accordance with an embodiment of the present disclosure. FIG. 5B is a rear view of the insert 46 shown in FIG. 5A, in accordance with an embodiment of the present disclosure. The wall plate 40 can further include an insert 46 to be received within an optional opening 100 of the wall plate 40. The insert 46, in some embodiments, can be cover the opening 100 and to secure the wall plate 40 to the outlet. The insert 46 can be made from non-conductive materials (e.g., polymeric materials). In an example embodiment, the insert 46 includes a through-hole 48 for receiving a fastener, such as a machine screw. When installed, the insert 46 is positioned in the opening 100 and a fastener is installed within the through-hole 48 to engage a threaded hole within a center of the outlet. The insert 46, in other embodiments, need not include a through hole and, thus can be installed without a fastener such as by snapping into place using tabs and slots. In such cases, the insert 46 can be then pressed onto the ledge 104. The insert 46 may cover features of the outlet, such as control buttons (e.g., test and reset buttons for a GFCI outlet), USB ports, or a light, but can be readily removed without the use of a tool, such as a screw driver. Numerous other insert configurations will be apparent in light of the present disclosure.

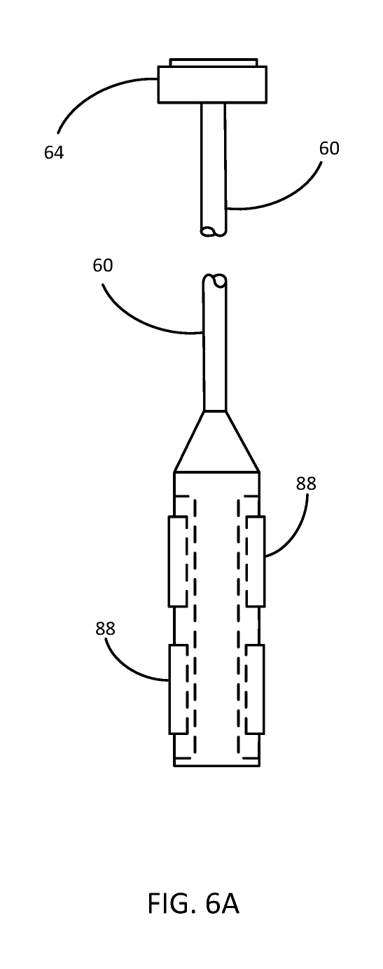

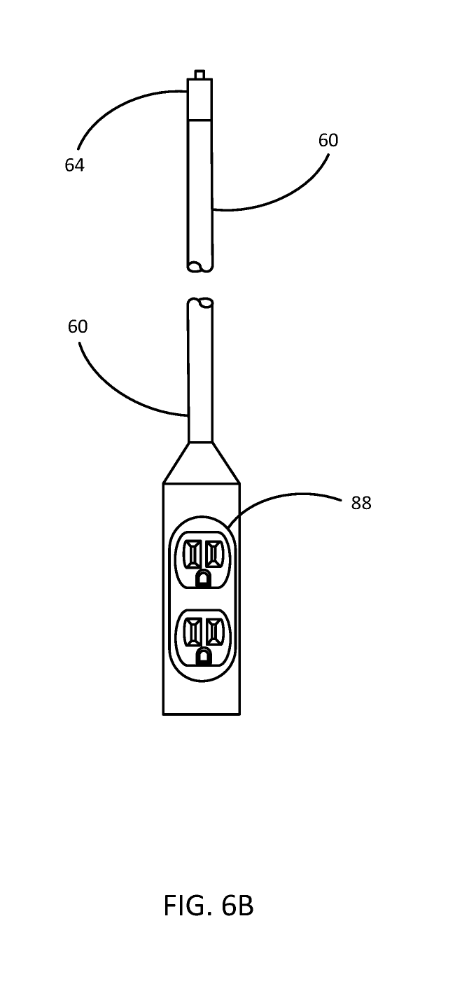

FIG. 6A is a front view of a cable 60 of the powered wall plate system 30, in accordance with an embodiment of the present disclosure. FIG. 6B is a side view of the cable 60 shown in FIG. 6A, in accordance with an embodiment of the present disclosure. Attachable to the wall plate 40 is a cable 60. Cable 60 transmits electrical power received from the outlet through the wall plate to one or more additional outlets. The cable 60 may be flexible or rigid. In addition, the cable 60 can be safely and easily removed and re-installed by disconnecting and reconnecting the cable 60 from the wall plate 40 using the connector 64, as described further herein. Thus, the cable 60 can be removed when not in use to provide an even more aesthetically pleasing appearance within the area and prevent inadvertent access to electrical power by children. In an example embodiment, the cable 60 is a three-wire cable that includes a sheath, insulation, two conductor wires and a ground wire. The conductor wires and ground wires can be manufactured from a variety of conductive materials, including copper and aluminum. The cable 60 can be any length suitable for connecting to the wall plate 40. In example embodiment, the cable 60 is between 8 and 12 inches in length and has a circular cross section. In other embodiments, the cable may be 2 feet (ft), 5 ft, 10 ft, or 20 ft in length and having a shape of a square, rectangle or hexagon. In some embodiments, the cable 60 is flat, similar to cables designed to run under carpet. The cable 60 may include an adhesive for securing it to the wall. No matter its configuration, the cable 60 when connect to the wall plate 40 provides a clean or otherwise streamlined appearance that promotes an aesthetic look or feel.

The cable 60 includes an additional outlet 88 (e.g., a female outlet) that can be a duplex receptacle for use with a 15 or 20 amp electrical circuit. The additional outlet 88 can be configured to receive standard two or three prong plugs of power cords for electrical appliances. In other embodiments, the additional outlet 88 may be a single receptacle or GFCI receptacle. The cable 60, in some embodiments, may include multiple additional outlets 88. The additional outlets 88 may also include additional features, such as USB ports, indicators, and lights, which are integrated into the additional outlets 88. The cable 60 may also include a GFCI circuit that can add GFCI capability to non-protected outlets.

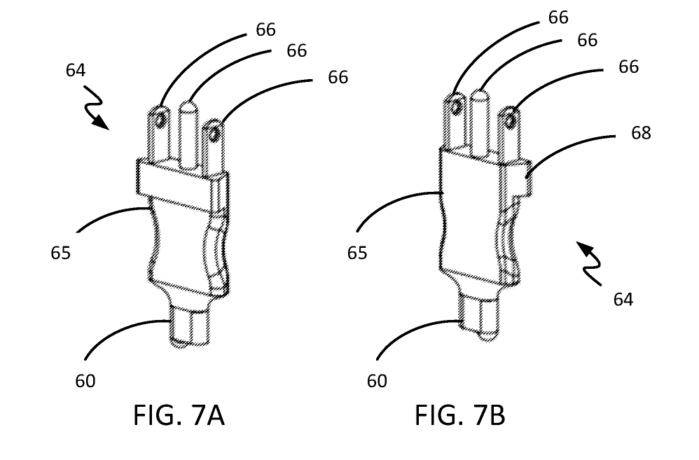

FIG. 7A is a front view of a connector 64 disposed on the cable 60, in accordance with an example embodiment of the present disclosure. FIG. 7B is a rear view of the connector 64 of FIG. 7A, in accordance with an example embodiment of the present disclosure. Attached to the cable 60 is a connector 64. Connector 64 is configured to engage the wall plate 40 to receive electrical power from the outlet and transfer that power to the cable 60. As shown, connector 64 is not interchangeable with a standard three prong outlet but is instead configured in a more planar arrangement that helps to reduce the profile of the connector 64. In an example embodiment, the connector 64 includes a base 65, conductors 66, and a locking tab 68. The base 65 supports the conductors 66 and locking tab 68. In addition, the base 65 contains the electrical connections between the wires of the cable 60 and the conductors 66. Attached to the base 65 are conductors 66 that engage corresponding female conductors in the wall plate 40 to receive electrical power from the outlet in which the wall plate 40 is installed. As can be seen, the conductors 66 may be pins or prongs or a combination thereof. In addition, the conductors 66 may be oriented in different directions from one another, depending on the application. The base 65, in some embodiments, can also include a locking tab 68, as described further herein. Numerous other locking feature configurations will be apparent in light of this disclosure.

Alternate Powered Wall Plate Device Configuration

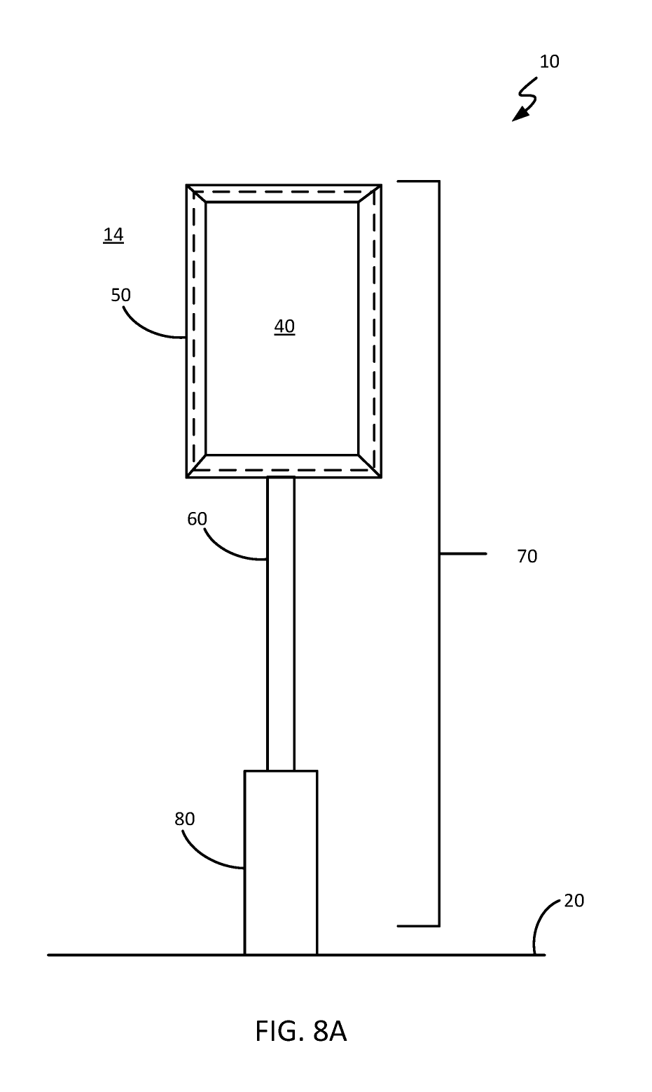

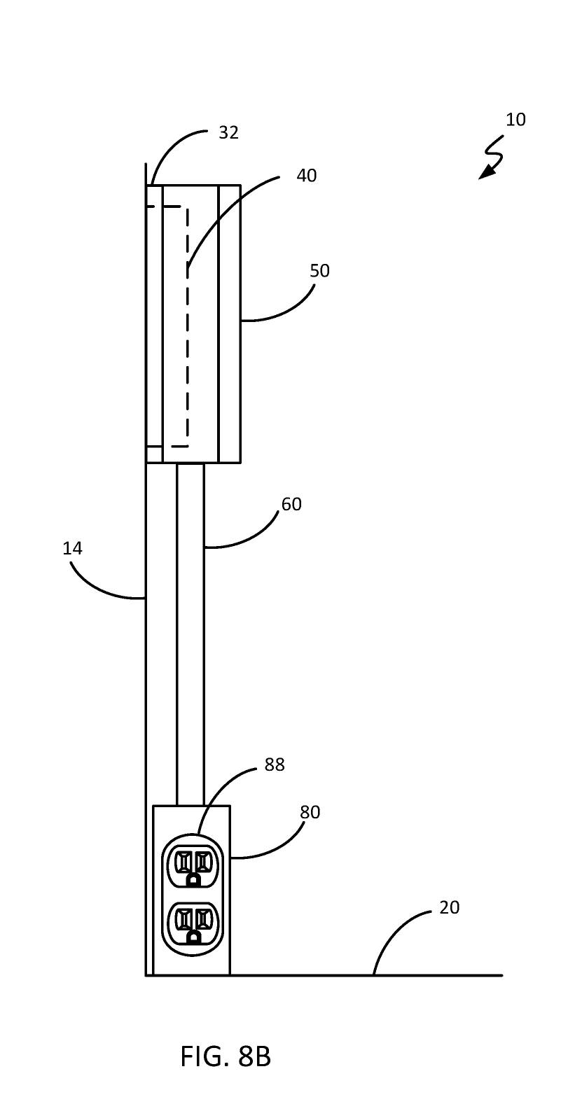

FIGS. 8A-B are front and side views of an exterior cover plate 50 installed over wall plate 40 within an area 10, in accordance with an embodiment of the present disclosure. As can be seen, the wall plate 40 (shown with dotted lines) is surrounded by a base plate 32 and an exterior cover plate 50. When installed, the base plate 32 and exterior cover plate 50 surround or otherwise enclose to prevent access to the wall plate 40. Note that not only are the sockets of the outlet inaccessible to fingers and toes but are also inaccessible to plugs, pins, paper clips, pens, pencils and other tools that children may use to try to access an outlet. In addition, the base plate 32 is configured to mount flush or otherwise in contact with a surface, such as a wall, that contains the outlet to prevent access to electrical connections between the outlet and the main power source. Together, the base plate 32 and exterior cover plate 50 cover the wall plate 40 to achieve an aesthetically pleasing look or appearance. Together, the base plate 32, wall plate 40 and exterior cover plate 50 may have a profile (distance from the wall) of less than 2 inches, less than 1.5 inches, less than 1 inch or less than 0.75 inch. Attached to the wall plate 40 as shown are the cable 60 and a distributor 80 that includes an additional outlet 88.

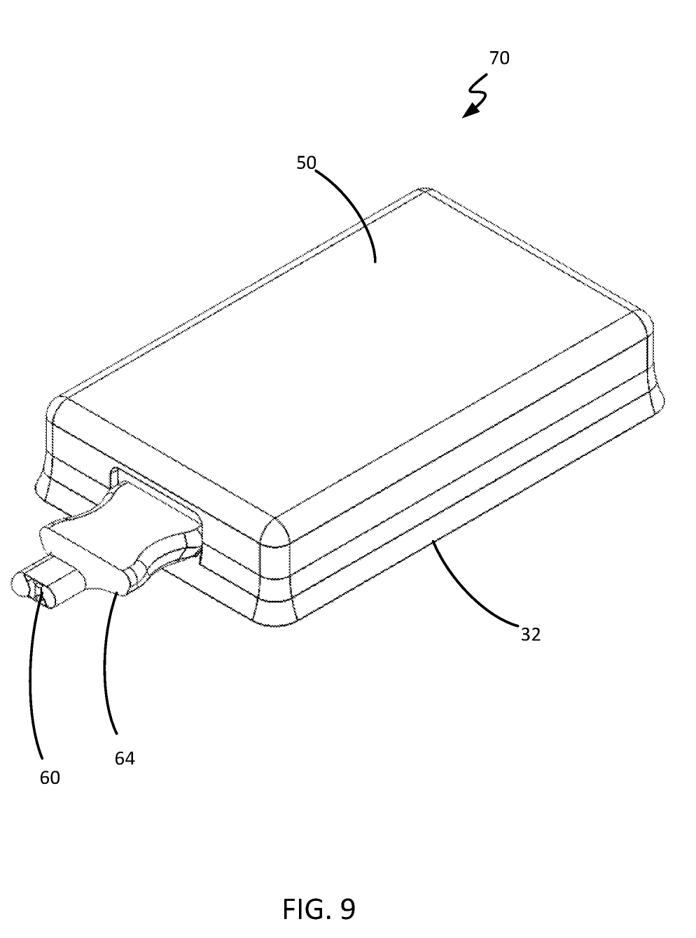

FIG. 9 is a perspective view of the powered wall plate system 70 of FIGS. 8A-B, in accordance with an embodiment of the present disclosure. FIG. 10 is an exploded view of the powered wall plate system 70 of FIG. 9, in accordance with an embodiment of the present disclosure. As can be seen in FIG. 10, the base plate 32 and exterior cover plate 50 surround the wall plate 40. The wall plate 40 and an insert 46 are positioned within a cavity 33 of the base plate 32 and covered by exterior cover plate 50. Note that the wall plate 40 is not attached to the base plate in this embodiment, and thus is installed and secured separately to the electrical box and/or outlet and can be positioned independently from the base plate 32 and exterior cover plate 50. The independent positioning of the wall plate 40 relative to the base plate 32 allows the wall plate 40 to be installed on electrical outlets that are not aligned (e.g., parallel with) to the base plate 32. Electrical outlets may be become misaligned for a number of reasons including improper installation of the electrical box (e.g., electrical box not parallel to a wall surface) and/or electrical outlet (e.g., electrical outlet not securely fastened to outlet box). In such cases, the base plate 32 may be affixed to the electrical box while the wall plate 40 is affixed to the outlet 18. In addition, the independent movement (or float) of the wall plate relative to the base plate can also allow the wall plate to be installed on outlets with varying distances between their faces (e.g., the surfaces that include female openings of the sockets) to surfaces in which the outlets are mounted thereto (e.g., a wall). From one outlet to the next, the distance from the outlet face to the surface in which it is mounted thereto can range from ⅛ of an inch to almost 7/16 of an inch off the surface. The powered wall plate system 70 addresses these variations in outlets installation, by allowing the wall plate 40 to float or otherwise be positioned independently within the base plate 32 and exterior cover plate 50.

Installed in the wall plate 40 is the connector 64 integrally attached (e.g., molded) to a cable 60. The connector 64 transfers electrical power from the wall plate 40 to the cable 60, as previously described herein. The connector 64 is retained within the wall plate 40 by the exterior cover plate 50. As previously mentioned, the connector 64 can include a locking tab 68 configured to prevent inadvertent removal of the connector 64 from the wall plate 40 when the exterior cover plate 50 is installed on the base plate 32. In an example embodiment, the locking tab 68 makes the connector 64 wider than the opening in the exterior cover plate 50. With the connector 64 installed within the wall plate 40, the locking tab 68 is positioned behind the flange of the exterior cover plate 50. Thus, any attempt to remove the connector 64 from the wall plate 40 with the exterior cover plate 50 installed is prevented because the locking tab 68 will contact the exterior cover plate 50. In various embodiments, the interaction of the connector 64 with the exterior cover plate 50 can withstand a force of greater than 10 lbs, greater than 20 lbs or greater than 30 lbs without being pulled from wall plate 40. Once the exterior cover plate 50 is removed, the connector 64 can be easily removed from wall plate 40.

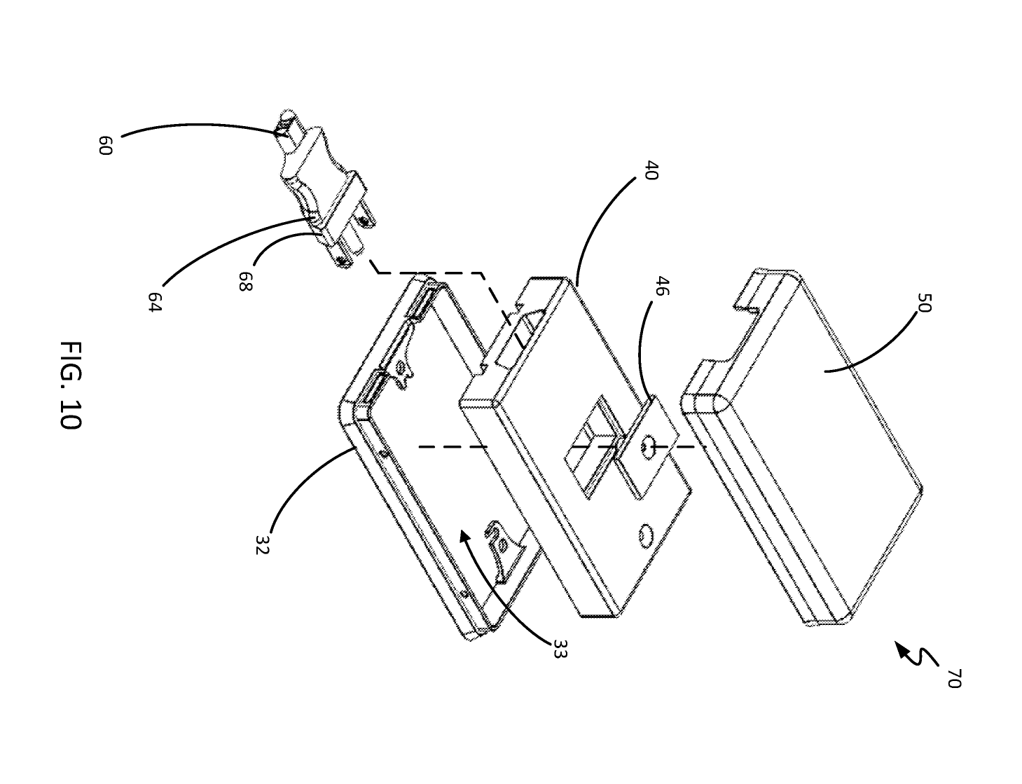

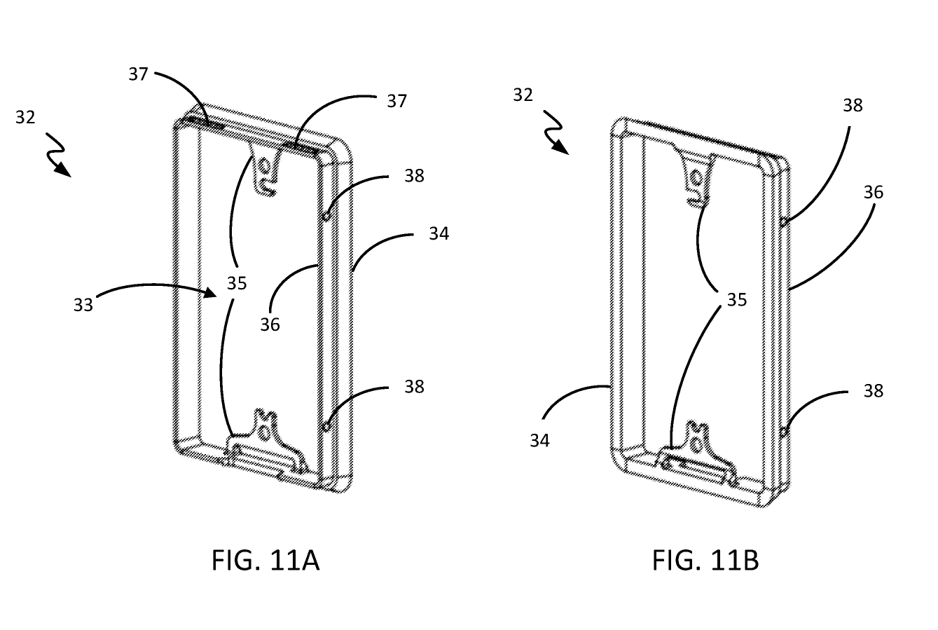

FIG. 11A is a front view of a base plate 32 of the powered wall plate system 70, in accordance with an embodiment of the present disclosure. FIG. 11B is a rear view of the base plate 32 shown in FIG. 11A, in accordance with an embodiment of the present disclosure. The powered wall plate system 70 includes a base plate 32 configured to house or otherwise contain the wall plate 40 and to receive exterior cover plate 50. In addition, the base plate 32 ensures that the powered wall plate system 70 is mounted flush against the surface (e.g., the wall) in which the outlet is installed. In an example embodiment, the base plate 32 is installed on or otherwise secured to an electrical box that contains the outlet. In the embodiment shown, the base plate 32 includes a base 34, tabs 35, a flange 36, recesses 37, and locking features 38. The base 34 defines a cavity 33 in which to receive the wall plate 40. Attached to the base 34 are tabs 35 for mounting the base plate 32 to the electrical box. The base plate 32 can be mounted onto the electrical box along with the electrical outlet and a common screw (or screws) may be used to mount both. Numerous other ways of attaching the base plate 32 to the electrical box will be apparent in light of the present disclosure.

The base plate 32 includes a flange 36 to receive the exterior cover plate 50 and further define the cavity 33 in which to receive the wall plate 40. In an example embodiment, the exterior cover plate 50 is secured or otherwise attached to the flange 36 using recesses 37 and locking features 38. The recesses 37, for example grooves, receive projections on the exterior cover plate 50, for example ridges, when the exterior cover plate 50 is installed onto the base plate 32. The recesses 37 enable the exterior cover plate 50 to be removed from the base plate 32 by pivoting the exterior cover plate 50 in relation to base plate 32. To further secure the exterior cover plate 50 onto the base plate 32, the flange 36 further includes locking features, such as depressions or dimples, which are configured to engage corresponding raised features, such as projections, protrusions or bumps, on the exterior cover plate 50. Numerous other methods of mounting the base plate 32 will be apparent in light of the present disclosure.

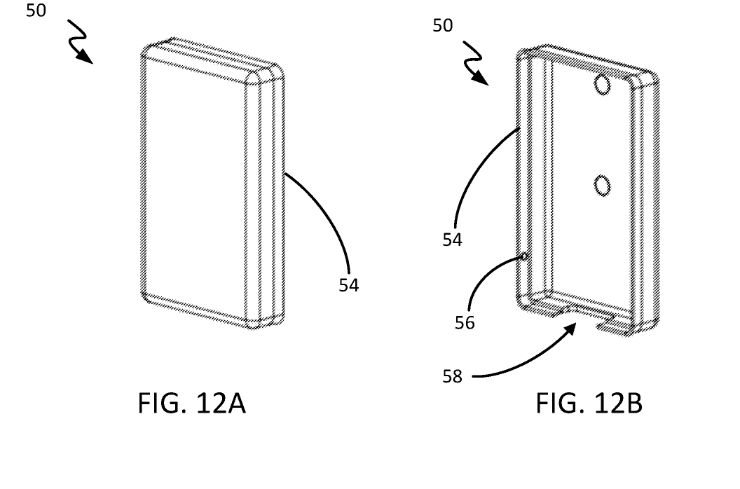

FIG. 12A is a front view of an exterior cover plate 50 of the powered wall plate system 70, in accordance with an example embodiment of the present disclosure. FIG. 12B is a rear view of the exterior cover plate 50 shown in FIG. 12A, in accordance with an example embodiment of the present disclosure. The exterior cover plate 50, in some embodiments, can be configured to cover or otherwise conceal both the wall plate 40 and electrical outlet to prevent inadvertent access to the outlet (e.g., by small children). In other embodiments, the exterior cover plate 50 is configured to surround a perimeter of the wall plate 40 (e.g., along a perimeter defined by the base plate 32), such that a face of the wall plate 40 can be exposed to the area. In addition, the exterior cover plate 50 also provides a smooth clean appearance. To achieve a desired aesthetic look or feel, the exterior cover plate 50 can be painted, plastered, or wallpapered. In some other instances the desired look or feel can be achieved by manufacturing the exterior cover plate 50 from materials including, composite woods, plastics (e.g., thermoplastics), or metallic materials, such as bronze or aluminum. Numerous other materials can be used to manufacture the exterior cover plate 50 in light of this disclosure. The exterior cover plate 50 may include features or patterns molded into the surface that can, for example, reduce glare and reflection.

The exterior cover plate 50, in an example embodiment, includes a flange 54, locking features 56, and an opening 58. The flange 54 mates with the base plate 32 to attach or otherwise secure the exterior cover plate 50 onto the base plate 32 (e.g., exterior cover plate 50 may snap onto to the base plate 32). To ensure that the exterior cover plate 50 is not inadvertently removed, the flange 54 includes locking features 56 that engage corresponding features on the base plate 32, as previously described. The locking features 56, for example, may be raised material, such as projections, protrusions, bumps, or ridges, formed using radius cuts or other machining or injection-molding techniques. The flange 54 further includes an opening 58 for receiving and retaining the connector 64 installed within the wall plate 40. In example embodiment, the opening 58 is smaller than a width of the connector 64 disposed on the cable 60. As a result, the connector 64 cannot be removed from the wall plate 40 unless the exterior cover plate 50 is removed from the base plate 32, as previously described herein. It may be notable that exterior cover plate 50 cannot be removed by applying a force in the same direction as is necessary to unplug cable 60. Therefore, someone pulling on cable 60 would not be able to remove exterior cover plate 50 using the same motion. In some embodiments, once the connector 64 is removed from the wall plate 40, the exterior cover plate 50 can be re-positioned (e.g., rotated 180 degrees) and attached to the base plate 32, such that there no exposed openings to access the wall plate 40, even in the absence of cable 60. Thus, when not in use the powered wall plate system 70 can be re-configured to prevent inadvertent access (e.g., by small children with the area) to electrical power from the outlet. Numerous other exterior cover plate configurations will be apparent in light of the present disclosure.

Attached to the wall plate 40 are the cable 60 and an additional outlet 88, as previously described herein. In some embodiments, the additional outlet 88 is disposed in a distributor 80 on cable 60. The distributor 80 can be physically and electrically connected to the second cable end and positioned at a point underneath the wall plate 40. It may be close to, or in contact with, the ground. In some embodiments, however, the distributor 80 may be located 1 foot (ft), 3 ft, 5 ft, 10 ft or 20 ft away from the wall plate 40 along one of several directions (e.g., parallel or perpendicular) relative to the wall 14. Numerous other ways for integrating or attaching the additional outlet 88 to the cable 60 will be apparent in light of the present disclosure.

Further Considerations

Numerous other configurations will be apparent in light of this disclosure. The wall plate may also include markings. The markings can instruct or otherwise guide a user regarding how to install the connector disposed on the cable into the wall plate. The markings, in some embodiments, can be painted, stamped, or raised markings that indicate a proper alignment for installing the connector into the wall plate.

In other embodiments of the present disclosure, the wall plate may be configured to receive a plurality of two or more cables. In an example embodiment, the wall plate includes four receptacles or ports, each located on a different surface along the perimeter of the wall plate. Thus, four cables can be connected to the wall plate at any one time and positioned in different directions therefrom. In some other embodiments, the two opposing sides of the wall plate may include one, two, or more receptacles, such that two or more cables can be connected to wall plate and be extended within the area in opposite directions. Numerous other configurations will be apparent in light of the present disclosure.

In some other embodiments of the present disclosure, the powered wall plate system may include two or more distributors that receive electrical power from the outlet. In an example embodiment, electrical distributors may each be connected to cables that are installed in different receptacles (e.g., a receptacle on each surface of the wall plate) of the wall plate. The electrical distributors, in other embodiments, may be connected in series with one another using the cables, such that there is a single cable that connects to the wall plate that provides electrical power to multiple distributors. Numerous other arrangements and configurations for installing the distributors will be apparent in light of the present disclosure.

The foregoing description of the embodiments of the present disclosure has been presented for the purposes of illustration and description. It is not intended to be exhaustive or to limit the present disclosure to the precise form disclosed. Many modifications and variations are possible in light of this disclosure. It is intended that the scope of the present disclosure be limited not by this detailed description, but rather by the claims appended hereto.

What is claimed is:

1. A powered wall plate system for an electrical outlet comprising:
a wall plate including a conductor having a first end and a second end, the first end of the conductor extending to be electrically engageable with at least one socket of the electrical outlet, wherein the wall plate is to be attached to the electrical outlet such that the wall plate is to cover the at least one socket of the electrical outlet; and
a removable cable including a first cable end and a second cable end, the first cable end includes a connector to engage the second end of the conductor at an angle of about 90 degrees with respect to the first end of the conductor, and the second cable end to include an additional electrical outlet.

2. The powered wall plate system of claim 1 further comprising:
a base plate to receive the wall plate, the base plate to be installed on an electrical box that contains the electrical outlet and includes a cavity therein to receive the wall plate; and
an exterior cover plate to be attached to the base plate so as to at least one of cover the wall plate and surround a perimeter of the wall plate.

3. The powered wall plate system of claim 2, wherein the at least one socket of the electrical outlet is a double socket, and the wall plate is to surround the electric outlet such that the double socket and one or more integrated features of the electric outlet are covered by the wall plate.

4. The powered wall plate system of claim 2, wherein the base plate includes in a flange to receive the exterior cover plate and define the cavity within the base plate, and the flange includes a locking feature to secure the exterior cover plate onto the base plate.

5. The powered wall plate system of claim 2, wherein the base plate and the electrical outlet are attached to the electrical box.

6. The powered wall plate system of claim 2, wherein the base plate includes one or more grooves to receive one or more corresponding features located on the exterior cover plate to secure the exterior cover plate to the base plate.

7. The powered wall plate system of claim 2, wherein the wall plate is installed onto the electrical outlet separately from the base plate and the exterior cover plate such that the wall plate is moveable relative to the base plate.

8. The powered wall plate system of claim 2, wherein the exterior cover plate includes a locking feature to secure the exterior cover plate to the base plate.

9. The powered wall plate system of claim 2, wherein the exterior cover plate is positioned onto the base plate such that the wall plate cannot be accessed.

10. The powered wall plate system of claim 2, wherein the exterior cover plate can be removed from the base plate by pivoting the exterior cover plate relative to the base plate.

11. The powered wall plate system of claim 2, wherein the connector includes a tab, the tab is to prevent removal of the connector from the wall plate when the exterior cover plate is installed on the base plate.

12. The powered wall plate system of claim 2, wherein the wall plate is moveable relative to the base plate and exterior cover plate when each of the wall plate, base plate and exterior cover plate are installed.

13. The powered wall plate system of claim 1 further comprising an opening disposed within the wall plate and an insert, the insert to be received within the opening.

14. The powered wall plate system of claim 13, wherein the opening provides access to a portion of the electrical outlet that does not include the at least one socket.

15. The powered wall plate system of claim 1, wherein the additional electrical outlet includes at least one of a light, an indicator, and a universal serial bus (USB) port.

16. A powered wall plate system for an electrical outlet comprising:
a base plate to be installed onto an electrical box that contains the electrical outlet, the base plate in contact with a surface that includes the electrical outlet and includes at least one tab for mounting the base plate to the electrical box and a flange that defines a cavity;
a wall plate disposed within the cavity of the base plate and to cover sockets of the electrical outlet, the wall plate further comprising
a conductor having a first end, the first end of the conductor is a plug to engage a socket of the electrical outlet,
an opening to provide access to a portion of the electrical outlet that does not include the sockets of the electrical outlet, and
an insert installed within the opening, the insert attached to the wall plate with a fastener that engages the electrical outlet;
an exterior cover plate to be installed onto the flange of the base plate and over the wall plate, the exterior cover plate including one or more locking features that engage the flange of the base plate to secure the exterior cover plate thereon; and
a cable including a first cable end and a second cable end, the first cable end including a connector to engage a second end of the conductor of the wall plate, and a distributor connected to the second cable end.

17. A powered wall plate system for an electrical outlet comprising:
a base plate to be installed on an electrical box that contains the electrical outlet, the base plate in contact with a surface that includes the electrical outlet and includes a cavity therein;
a wall plate disposed within the cavity of the base plate and to cover sockets of the electrical outlet, the wall plate further comprising
a conductor having a first end, the first end of the conductor to engage at least one socket of the electrical outlet, and
an opening to provide access to a portion of the electrical outlet that does not include the sockets; and
an exterior cover plate to be positioned onto the base plate so as to cover the wall plate.

18. The powered wall plate system of claim 17, further comprising:
a removable cable including a first cable end and a second cable end, the first cable end includes a connector to engage a second end of the conductor of the wall plate, and the second cable end includes an additional electrical outlet.

19. The powered wall plate system of claim 18 wherein the first cable end cannot be removed from the second end of the conductor of the wall plate when the exterior cover plate is installed onto the base plate.

20. The powered wall plate system of claim 17, further comprising an insert positioned in the opening to secure the wall plate to the electrical outlet with a fastener, the fastener is in contact with the insert and engages the electrical outlet.
